(19) United States
(12) Patent Application Publication
(10) Pub. No.: US 2012/0106215 A1
(43) Pub. Date: May 3, 2012

(54) POWER CONVERSION APPARATUS AND BROWN-OUT PROTECTION METHOD THEREOF

(75) Inventor: Ju-Lin Chia, Hsinchu (TW)

(73) Assignee: POWER FOREST TECHNOLOGY CORPORATION, Hsinchu (TW)

(21) Appl. No.: 13/006,426

(22) Filed: Jan. 14, 2011

(30) Foreign Application Priority Data
Oct. 27, 2010 (TW) 99136789

(51) Int. Cl. H02M 7/217

(52) U.S. Cl. 363/124

(57) ABSTRACT

A power conversion apparatus and a brown-out protection method are provided. The brown-out protection method includes sampling a rectification signal relating to an AC voltage received by the power conversion apparatus by adopting a discrete sampling means; and when a peak value of the sampled rectification signal has reached to a predetei mined value within a predetermined duration, making a pulse width modulation (PWM) control chip in the power conversion apparatus provide a PWM signal to switch a power switch in the power conversion apparatus, and thereby making the power conversion apparatus provide an output voltage to an electronic device; otherwise, making the PWM control chip to stop providing the PWM signal.

### CROSS-REFERENCE TO RELATED APPLICATION

This application claims the priority benefit of Taiwan application serial no. 99136789, filed on Oct. 27, 2010. The entirety of the above-mentioned patent application is hereby incorporated by reference herein and made a part of specification.

### BACKGROUND

1. Field of the Invention

The invention relates to a power conversion apparatus. Particularly, the invention relates to a power conversion apparatus capable of assisting a power on function and a brown-out protection function.

2. Description of Related Art

A power conversion apparatus is mainly used for converting a high-voltage and low-stability alternating current (AC) voltage provided by a power company into a low-voltage and stable direct current (DC) voltage suitable for various electronic devices. Therefore, the power conversion apparatus is widely used in electronic devices such as computers, office automation equipments, industrial control equipments, and communication equipments, etc.

A control structure in the power conversion apparatus is generally implemented by a pulse width modulation (PWM) control chip. In an actual application, the PWM control chip probably provides a PWM signal to switch (i.e. turn on/off) a power switch in the power conversion apparatus before an AC voltage received by the power conversion apparatus is stable (for example, brown-out, which can be interpreted as a peak value of a rectification signal relating to the received AC voltage does not reach a minimum voltage required by an electronic device). Therefore, under a condition of constant power, the above operation may cause irrevocable damage of internal devices of the power conversion apparatus and/or the electronic device.

### SUMMARY OF THE INVENTION

Accordingly, the invention is directed to a power conversion apparatus capable of assisting a power on function and a brown-out protection function, which can assist activating a power of a pulse width modulation (PWM) control chip and control the PWM control chip to stop providing a PWM signal when a received alternating current (AC) voltage is still not stable (i.e. brown-out).

The invention provides a power conversion apparatus including a power conversion stage, a rectification unit, a transformer, a first power switch and a PWM control chip. The power conversion stage receives an AC voltage, and converts the AC voltage to provide an input voltage. The rectification unit receives the AC voltage and rectifies the AC voltage to provide a rectification signal. The transformer has a primary side, a first secondary side and a second secondary side. A first end of the primary side receives the input voltage, the first secondary side provides an output voltage to an electronic device, and the second secondary side provides a system voltage.

A first end of the first power switch is coupled to a second end of the primary side, a second end of the first power switch is coupled to a ground potential, and a control end of the first power switch receives a PWM signal. The PWM control chip is coupled to the rectification unit, the transformer and the first power switch for receiving the system voltage, and is operated under the system voltage with assistance of the rectification signal, and samples the rectification signal by using a discrete sampling means, so as to provide the PWM signal to switch the first power switch when a peak value of the sampled rectification signal has reached to a predetermined value within a predetermined duration.

In an embodiment of the invention, the PWM control chip includes a PWM signal generator and a brown-out protection unit. The PWM signal generator is coupled to the control end of the first power switch for providing the PWM signal in response to a brown-out protection signal. The brown-out protection unit is coupled to the PWM signal generator for receiving and providing the rectification signal to assist the PWM control chip operating under the system voltage, and sampling the rectification signal by using the discrete sampling means, so as to output the brown-out protection signal when the peak value of the rectification signal has reached to the predetermined value within the predetermined duration.

In an embodiment of the invention, the brown-out protection unit includes a first resistor, a switch, a second power switch, a first to a six transistors, a reference current source, a comparator and a digital signal processor. A first end of the first resistor receives the rectification signal. A first end of the second power switch is coupled to a second end of the first resistor, and a control end of the second power switch receives a first control signal. A first end of the switch is coupled to a second end of the second power switch, a second end of the switch is coupled to the system voltage, and a control end of the switch receives a switching signal. A gate of the first transistor receives the first control signal, and a drain of the first transistor is coupled to the second end of the second power switch.

A gate and a drain of the second transistor are coupled to a source of the first transistor, and a source of the second transistors is coupled to the ground potential. A gate of the third transistor is coupled to the gate of the second transistor, and a source of the third transistor is coupled to the ground potential. A source of the fourth transistor is coupled to a bias, and a gate and a drain of the fourth transistor are coupled to a drain of the third transistor. A gate of the fifth transistor is coupled to the gate of the fourth transistor, and a source of the fifth transistor is coupled to the bias. The reference current source is coupled between a drain of the fifth transistor and the ground potential. A gate of the sixth transistor receives a second control signal inverted to the first control signal, a drain of the sixth transistor is coupled to the drain of the fifth transistor, and a source of the sixth transistor is coupled to the ground potential.

A first input terminal of the comparator is coupled to the drain of the fifth transistor, a second input terminal of the comparator receives a reference voltage, and an output terminal of the comparator outputs a comparison signal. The digital signal processor provides the first control signal, the second control signal and the switching signal during an initial phase of the power conversion apparatus, so that the PWM control chip is operated under the system voltage with assistance of the rectification signal, and provides the first control signal and the second control signal in response to a clock signal during an operation phase of the power conversion apparatus, so as to perform a discrete sampling to the rectification signal, and record the comparison signal relating to the discrete sampling, and accordingly output the brown-out protection signal when the peak value of the rectification signal has reached to the predetermined value within the predetermined duration.

In an embodiment of the invention, the predetermined duration includes N cycles of the rectification signal, where N is a positive integer. In this case, the first control signal and the second control signal provided by the digital signal processor during the initial phase of the power conversion apparatus are used to sample each of the N cycles of the rectification signal for M times, so that the digital signal processor samples the rectification signal for N*M times during the initial phase of the power conversion apparatus, where M is less than N.

In an embodiment of the invention, an i-th sampling time Tᵢ that the digital signal processor samples the rectification signal is equal to an (i−1)-th sampling time Tᵢ₋₁ added by a predetermined time, where i is an odd positive integer. An (i+1)-th sampling time Tᵢ₊₁ that the digital signal processor samples the rectification signal is equal to the i-th sampling time Tᵢ added by the predetermined time and a offset time ΔT.

In an embodiment of the invention, the first and the second power switches, the first to the third transistors and the sixth transistor are respectively an N-type transistor, and the fourth and the fifth transistors are respectively a P-type transistor.

In an embodiment of the invention, a size of the second transistor is K times greater than that of the third transistor, and sizes of the fourth transistor and the fifth transistor are the same, where K is a positive integer.

In an embodiment of the invention, the power conversion stage includes a full-bridge rectifier and a filter capacitor. The full-bridge rectifier receives the AC voltage, and performs a full-wave rectification to the AC voltage for outputting. The filter capacitor is coupled to the full-bridge rectifier, and filters an output of the full-bridge rectifier, so as to provide the input voltage.

In an embodiment of the invention, the rectification unit includes a first diode and a second diode. Anodes of the first and the second diodes receive the AC voltage, and cathodes of the first and the second diodes provide the rectification signal.

In an embodiment of the invention, the power conversion apparatus further includes a sensing resistor coupled between the second end of the first power switch and the ground potential. In this case, the PWM control chip further includes an over-current protection unit coupled to a node between the first power switch and the sensing resistor, for receiving and comparing a voltage of the node and a predetermined over-current protection reference voltage, so as to determine whether or not to activate an over-current protection mechanism to control the PWM signal generator to whether or not generate the PWM signal.

In an embodiment of the invention, the power conversion apparatus further includes a feedback unit for receiving the output voltage, and accordingly outputting a feedback signal relating to a loading status of the electronic device. In this case, the PWM control chip further adjusts the PWM signal according to the feedback signal.

The invention provides a brown-out protection method for a power conversion apparatus. The brown-out protection method can be described as follows. A rectification signal relating to an AC voltage received by the power conversion apparatus is sampled by using a discrete sampling means. When a peak value of the sampled rectification signal has reached to a predetermined value within a predetermined duration, a pulse width modulation (PWM) control chip in the power conversion apparatus provides a PWM signal to switch a power switch in the power conversion apparatus, so as to make the power conversion apparatus provide an output voltage to an electronic device. Otherwise, the PWM control chip stops providing the PWM signal.

According to the above descriptions, in the power conversion apparatus and the brown-out protection method of the invention, the discrete sampling means (i.e. a digital signal processing method) is used to sample the rectification signal relating to the AC voltage received by the power conversion apparatus. Once the peak value of the sampled rectification signal has reached to a predetermined value within a predetermined duration (i.e. the AC voltage received by the power conversion apparatus is stable, or reaches a minimum voltage required by the electronic device), the PWM control chip provides the PWM signal to switch the power switch, otherwise (i.e. the AC voltage received by the power conversion apparatus is still not stable, or does not reach the minimum voltage required by the electronic device), the PWM control chip stops providing the PWM signal. In this way, problems mentioned in the related art can be effectively resolved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a power conversion apparatus according to an embodiment of the invention.

FIG. 2 is a schematic diagram illustrating a power conversion stage according to an embodiment of the invention.

FIG. 3 is a schematic diagram illustrating a rectification unit according to an embodiment of the invention.

FIG. 4 is a schematic diagram illustrating a brown-out protection unit according to an embodiment of the invention.

FIG. 5 is an operation explanation diagram of a brown-out protection unit according to an embodiment of the invention.

FIG. 6 is a schematic diagram of an AC voltage and a system voltage according to an embodiment of the invention.

FIG. 7 is a schematic diagram of stacking sampled rectification signals according to an embodiment of the invention.

FIG. 8 is a flowchart illustrating a brown-out protection method for a power conversion apparatus according to an embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

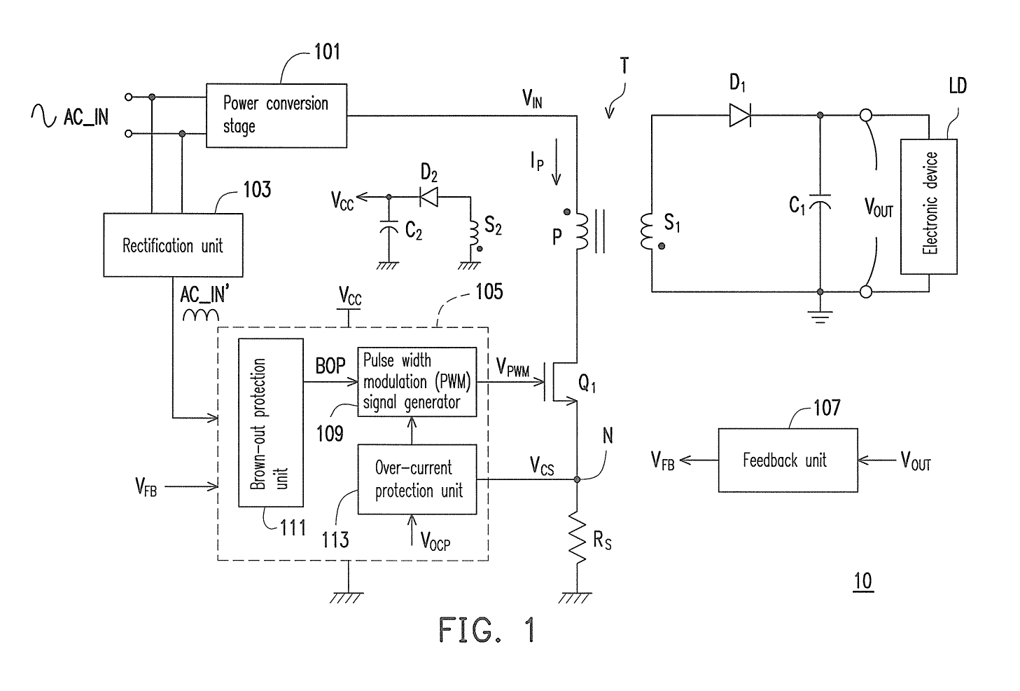

FIG. 1 is a schematic diagram illustrating a power conversion apparatus 10 according to an embodiment of the invention. Referring to FIG. 1, the power conversion apparatus 10 includes a power conversion stage 101, a rectification unit 103, a pulse width modulation (PWM) control chip 105, a feedback unit 107, a transformer T, a power switch Q₁, a sensing resistor R_{S}, diodes D₁ and D₂ and capacitors C₁ and C₂.

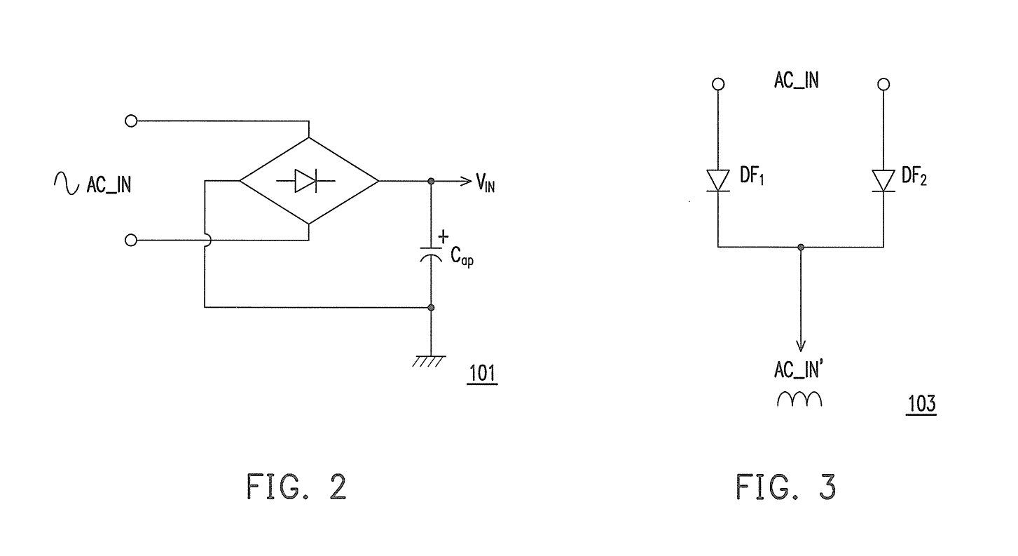

In the present embodiment, the power conversion stage 101 receives an alternating current (AC) voltage AC_IN, and converts the AC voltage AC_IN to provide an input voltage V_{IN}. In detail, FIG. 2 is a schematic diagram illustrating the power conversion stage 101 according to an embodiment of the invention. Referring to FIG. 2, the power conversion stage 101 can be a full-bridge power converter, and may include a full-bridge rectifier 201 and a filter capacitor Cap. The full-bridge rectifier 201 receives the AC voltage AC_IN, and performs a full-wave rectification to the AC voltage AC_IN for outputting. The filter capacitor Cap is coupled to the full-bridge rectifier 201, and filters an output of the full-bridge rectifier 201 to provide the input voltage V_{IN}.

In brief, once the power conversion stage 101 receives the AC voltage AC_IN provided by, for example, a power company, the power conversion stage 101 performs the full-wave rectification and filtering to the AC voltage AC_IN, so as to provide the input voltage V_{IN}. However, the invention is not limited thereto. Namely, the other types of the power converter can also be used, for example, a half-bridge power converter.

The rectification unit 103 receives the AC voltage AC_IN and rectifies the AC voltage AC_IN to provide a rectification signal AC_IN′. In detail, FIG. 3 is a schematic diagram illustrating the rectification unit 103 according to an embodiment of the invention. Referring to FIG. 3, the rectification unit 103 may include two diodes DF₁ and DF₂. Anodes of the diodes DF₁ and DF₂ receive the AC voltage AC_IN, and cathodes of the diodes DF₁ and DF₂ provide the rectification signal AC_IN′. In brief, the diodes DF₁ and DF₂ convert the AC voltage AC_IN into a full-wave rectification signal.

The transformer T has a primary side P and secondary sides S₁ and S₂. A first end of the primary side P of the transformer T receives the input voltage V. The secondary side S₁ of the transformer T provides an output voltage V_{OUT} to an electronic device LD in response to a switching operation of the power switch Q₁. The secondary side S₂ of the transformer T provides a system voltage V_{CC} in response to the switching operation of the power switch Q₁.

Generally, an AC voltage (determined by a turn ratio of the primary side P and the secondary side S₁ of the transformer T) on the secondary side Sᵢ of the transformer T is converted into the output voltage V_{OUT} through rectification of the diode D₁ and filtering of the capacitor C₁. Similarly, an AC voltage (determined by a turn ratio of the primary side P and the secondary side S₂ of the transformer T) on the secondary side S₂ of the transformer T is also converted into the system voltage V_{CC} through rectification of the diode D₂ and filtering of the capacitor C₂.

A first end of the power switch Q₁ is coupled to a second end of the primary side P of the transformer T, a second end of the power switch Q₁ is coupled to a ground potential through the sensing resistor R_{S}, and a control end of the power switch Q₁ receives a PWM signal V_{PWM} provided by the PWM control chip 105. The feedback unit 107 receives the output voltage V_{OUT}, and accordingly outputs a feedback signal V_{FB} relating to a loading status of the electronic device LD, so that the PWM control chip 105 may adjust the PWM signal V_{PWM} according to the feedback signal V_{FB}.

It should be noticed that any circuit pattern capable of outputting the feedback signal relating to the loading status of the electronic device LD (for example, a feedback circuit applying a resistor divider and an optical coupler) can be used as the feedback unit 107 of the present embodiment, so that implementation of the feedback circuit 107 is not limited by the present embodiment.

The PWM control chip 105 is coupled to the rectification unit 103, the transformer T and the power switch Q₁ for receiving the system voltage V_{CC}, and is operated under the system voltage V_{CC} with assistance of the rectification signal AC_IN′, and samples the rectification signal AC_IN′ by using a discrete sampling means, so as to provide the PWM signal V_{PWM} to switch the power switch Q₁ when a peak value of the rectification signal AC_IN′ has reached to a predetermined value (for example, the minimum voltage required by the electronic device LD) within a predetermined duration (which is described later).

In detail, the PWM control chip 105 may include a PWM signal generator 109, a brown-out protection unit 111 and an over-current protection unit 113. The PWM signal generator 109 is coupled to the control end of the power switch Q₁ for providing the PWM signal V_{PWM} in response to a brown-out protection signal BOP output by the brown-out protection unit 111.

The brown-out protection unit 111 is coupled to the PWM signal generator 109, which receives and provides the rectification signal AC_IN′ to assist the PWM control chip 105 operating under the system voltage VCC, and samples the rectification signal AC_IN′ by using the discrete sampling means, so as to output the brown-out protection signal BOP to make the PWM signal generator 109 provide the PWM signal V_{PWM} when the peak value of the rectification signal AC_IN′ has reached to the minimum voltage (for example, 90 Vac, though the invention is not limited thereto) required by the electronic device LD within N cycles (N is a positive integer) of the rectification signal AC_IN′.

The over-current protection unit 113 is coupled to a node N between the power switch Q₁ and the sensing resistor R_{S} for receiving and comparing a voltage V_{CS} of the node N and a predetermined over-current protection reference voltage V_{OCP}, so as to determine whether or not to activate an over-current protection mechanism to control the PWM signal generator 109 to whether or not generate the PWM signal V_{PWM}, and accordingly avoid a damage/burnout of the power switch Q₁ and/or the electronic device LD due to that a current I_{P} flowing through the primary side P of the transformer T is too large (i.e. over-current). For example, when the voltage V_{CS} of the node N is greater than the predetermined over-current protection reference voltage V_{OCP}, the over-current protection unit 113 activates the over-current protection mechanism, so as to control the PWM signal generator 109 to stop generating the PWM signal V_{PWM}, and conversely control the PWM signal generator 109 to normally generate the PWM signal V_{PWM}.

Herein, reviewing the content disclosed in the related art, conventionally, the PWM control chip probably provides the PWM signal to switch (i.e. turn on/off) the power switch in the power conversion apparatus before the AC voltage received by the power conversion apparatus is stable (for example, brown-out, which can be interpreted as the peak value of the rectification signal relating to the received AC voltage does not reach the minimum voltage required by the electronic device). Therefore, under a condition of constant power, the above operation may cause irrevocable damage of the internal devices of the power conversion apparatus and/or the electronic device.

Therefore, in the present embodiment, the brown-out protection unit 111 is used to resolved the problem mentioned in the related art, which can assist activating the power of the PWM control chip 105, and control the PWM control chip 105 to stop providing the PWM signal V_{PWM} when the AC voltage received by the power conversion apparatus 10 is still not stable (i.e. brown-out, or the minimum voltage required by the electronic device LD is not reached), so as to avoid irrevocable damage of the internal devices of the power conversion apparatus 10 and/or the electronic device LD.

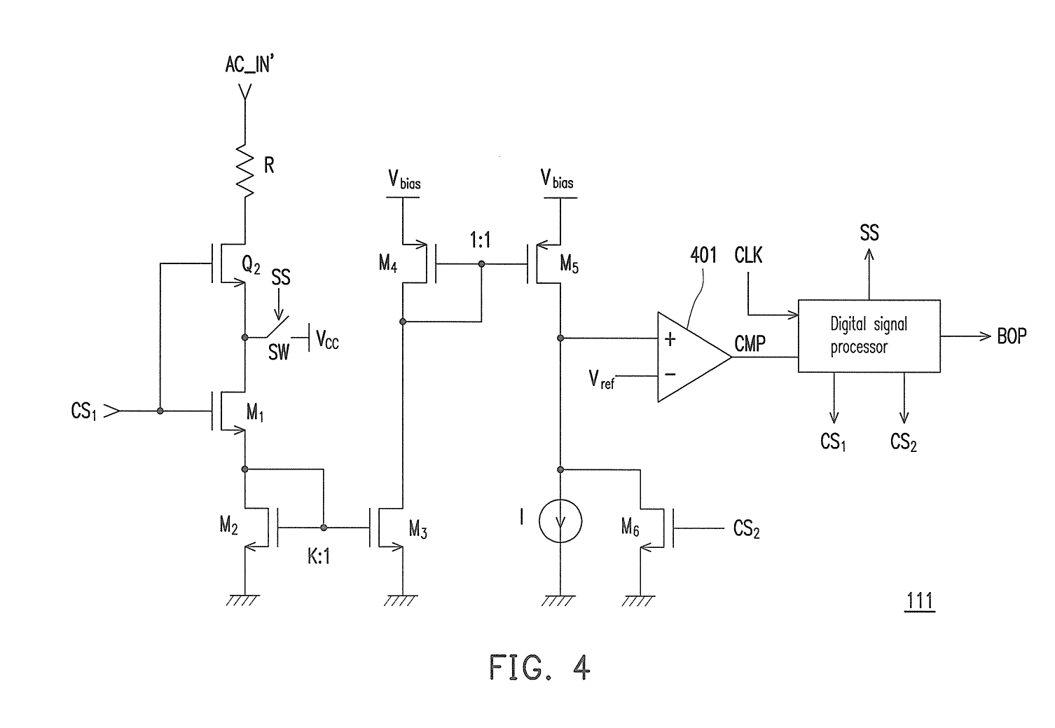

In detail, FIG. 4 is a schematic diagram illustrating the brown-out protection unit 111 according to an embodiment of the invention. Referring to FIG. 4, the brown-out protection unit 111 may include a resistor R, a power switch Q₂, a switch SW, transistors M₁-M₆, a reference current source I, a comparator 401 and a digital signal processor (DSP) 403. In the present embodiment, a first end of the resistor R receives the rectification signal AC_IN′. A first end of the power switch Q₂ is coupled to a second end of the resistor R, and a control end of the power switch Q₂ receives a control signal CS₁ provided by the DSP 403. A first end of the switch SW is coupled to a second end of the power switch Q₂, a second end of the switch SW is coupled to the system voltage V_{CC}, and a control end of the switch SW receives a switching signal SS provided by the DSP 403.

A gate of the transistor M₁ receives the control signal CS₁, and a drain of the transistor M₁ is coupled to the second end of the power switch Q₂. A gate and a drain of the transistor M₂ are coupled to a source of the transistor M₁, and a source of the transistors M₂ is coupled to the ground potential. A gate of the transistor M₃ is coupled to the gate of the transistor M₂, and a source of the transistor M₃ is coupled to the ground potential. A size of the transistor M₂ is K times (K is a positive integer, for example, 100, though the invention is not limited thereto) greater than that of the transistor M₃.

A source of the transistor M₄ is coupled to a bias Vbias, and a gate and a drain of the transistor M₄ are coupled to a drain of the transistor M₃. A gate of the transistor M₅ is coupled to the gate of the transistor M₄, and a source of the transistor M₅ is coupled to the bias Vbias. Sizes of the transistors M₄ and M₅ are the same. The reference current source I is coupled between a drain of the transistor M₅ and the ground potential. A gate of the transistor M₆ receives a control signal CS₂ inverted to the control signal CS₁, a drain of the transistor M₆ is coupled to the drain of the transistor M₅, and a source of the transistor M₆ is coupled to the ground potential. The power switches Q₁ and Q₂, the transistors M₁-M₃ and the transistor M₆ are N-type transistors, and the transistors M₄ and M₅ are P-type transistors.

A first input terminal (i.e. a positive (+) input terminal) of the comparator 401 is coupled to the drain of the transistor M₅, a second input terminal (i.e. a negative (−) input terminal) of the comparator 401 receives a reference voltage Vref, and an output terminal of the comparator 401 outputs a comparison signal CMP. A current Iref of the reference current source I is equal to the reference voltage Vref divided by a predetermined resistance value Rpre, i.e. Iref=Vref/Rpre.

The DSP 403 provides the control signals CS₁ and CS₂ and the switching signal SS during an initial phase of the power conversion apparatus 10, so that the rectification signal AC_IN′ can assist the PWM control chip 105 operating under the system voltage V_{CC}, and during an operation phase of the power conversion apparatus 10, the DSP 403 provides the control signals CS₁ and CS₂ in response to a clock signal CLK, so as to perform a discrete sampling to the rectification signal AC_IN′, and record the comparison signal CMP relating to the discrete sampling, and accordingly output the brown-out protection signal BOP to the PWM signal generator 109 when the peak value of the rectification signal AC_IN′ has reached to the minimum voltage required by the electronic device LD within N cycles of the rectification signal AC_IN′ (i.e. the AC voltage AC_IN is probably stable), so as to control the PWM signal generator 109 to provide/generate the PWM signal V_{PWM} to the power switch Q₁.

It can be known that the DSP 403 does not output the brown-out protection signal BOP to the PWM signal generator 109 when the peak value of the rectification signal AC_IN′ does not reach to the minimum voltage required by the electronic device LD within N cycles of the rectification signal AC_IN′ (i.e. the AC voltage AC_IN is not stable), so that the PWM signal generator 109 stops providing/generating the PWM signal V_{PWM} to the power switch Q₁.

In this way, the PWM control chip 105 stops providing the PWM signal V_{PWM} when the AC voltage AC_IN received by the power conversion apparatus 10 is not stable (for brown-out, which can be interpreted as the peak value of the rectification signal AC_IN′ relating to the received AC voltage AC_IN does not reach to the minimum voltage required by the electronic device LD), so as to stop switching (i.e. turning on/off) the power switch Q₁ of the power conversion apparatus 10, and accordingly avoid irrevocable damage of the internal devices of the power conversion apparatus 10 and/or the electronic device LD.

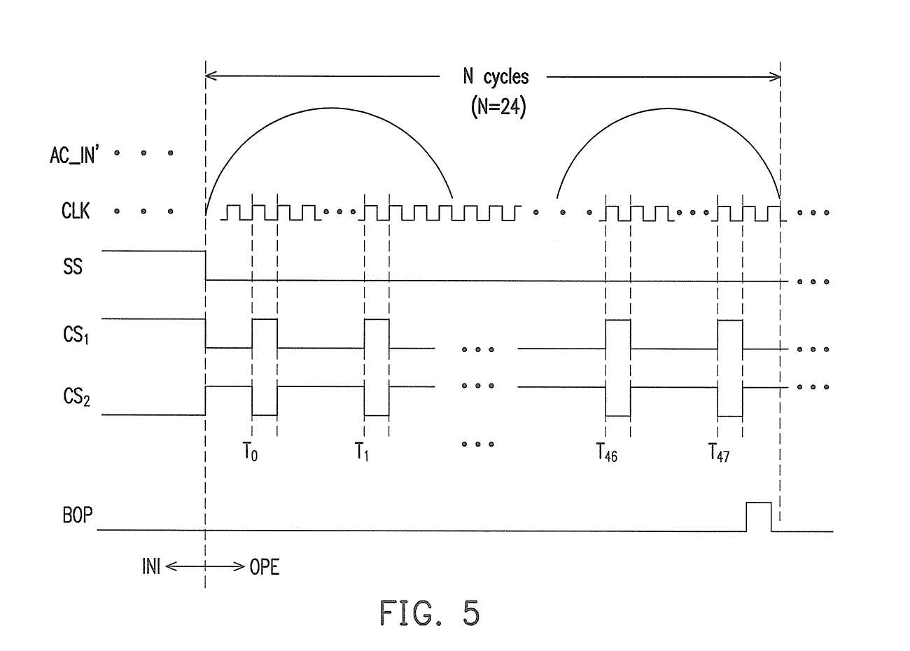

In detail, FIG. 5 is an operation explanation diagram of the brown-out protection unit 111 according to an embodiment of the invention. Referring to FIG. 4 and FIG. 5, first, in the initial phase INI of the power conversion apparatus 10, for example, in the beginning that the power conversion apparatus 10 receives the AC voltage AC_IN provided by the power company, since the AC voltage AC_IN is not stable, the DSP 403 continually provides the high level control signal CS₁ and the switching signal SS and the low level control signal CS₂ and the brown-out protection signal BOP during the initial phase INI. Therefore, the PWM signal generator 109 stops providing the PWM signal V_{PWM} to the power switch Q₁ in response to the low level brown-out protection signal BOP.

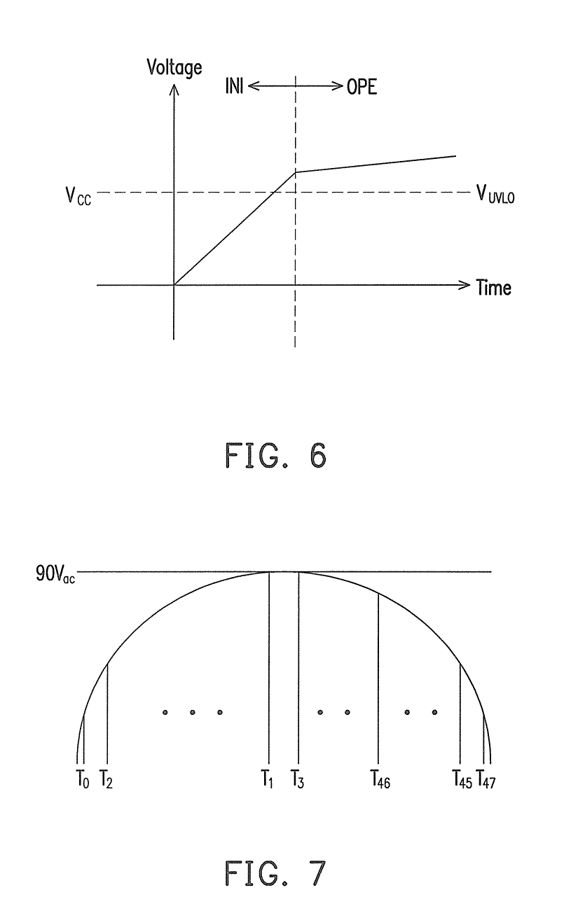

Meanwhile, the power switch Q₂ and the switch SW are turned on in response to the high level control signal CS₁ and the switching signal SS, so that the rectification signal AC_IN′ is provided to the system voltage V_{CC} on the secondary side S₂ of the transformer T through the resistor R, the power switch Q₂ and the switch SW. Therefore, the rectification signal AC_IN′ may assist the PWM control chip 105 operating under the system voltage V_{CC}, i.e. achieve a minimum operation voltage V_{UVLO} (shown by a climbing stage of the system voltage V_{CC} of FIG. 6) of the PWM control chip 105. When the rectification signal AC_IN′ assists the PWM control chip 105 operating under the system voltage V_{CC}, the DSP 403 changes states of the control signals CS₁ and CS₂ and the switching signal SS, and maintains the state of the brown-out protection signal BOP, so as to turn off the power switch Q₂ and the switch SW. In other words, during the initial phase INI of the power conversion apparatus 10, the brown-out protection unit 111 turns on the power switch Q₂ and the switch SW to assist activating the power of the PWM control chip 105. Once the power of the PWM control chip 105 is activated, the power switch Q₂ and the switch SW are turned off.

On the other hand, during the operation phase OPE of the power conversion apparatus 10, since the AC voltage AC_IN is probably not stable, i.e. the peak value of the rectification signal AC_IN′ does not reach to the minimum voltage (for example, 90 Vac, though the invention is not limited thereto) required by the electronic device LD, the DSP 403 may discretely provide the control signals CS₁ and CS₂ during such operation phase OPE, so as to perform discrete sampling to the rectification signal AC_IN′. In an embodiment of the invention, the control signals CS₁ and CS₂ provided by the DSP 403 during the operation phase OPE of the power conversion apparatus 10 are used to sample each of the N cycles (N=24, i.e. the aforementioned predetermined duration, though the invention is not limited thereto) of the rectification signal AC_IN′ for twice (shown in FIG. 5, though the invention is not limited thereto), i.e. total 48 samplings.

Moreover, if the 24 cycles are stacked, as shown in FIG. 7, sampling time T₀-T₄₇ of the 48 samplings can be respectively represented as follows:
T₀=0 (i.e. an initial time point, though the invention is not limited thereto);
T₁=T₀+4 ms (i.e. a predetermined time);
T₂=T₁+4 ms+ΔT (ΔT=0.15 ms, i.e. an offset time, though the invention is not limited thereto);
T₃=T₂+4 ms;
T₄=T₃+4 ms+ΔT;
T₅=T₄+4 ms;
T₆=T₅+4 ms+ΔT;
. . . ;
T₄₆=T₄₅+4 ms+ΔT; and
T₄₇=T₄₆+4 ms.

According to the above conditions, a frequency of the clock signal CLK received by the DSP 403 can be set to 65 KHz, though based on different setting conditions, the frequency of the clock signal CLK can also be changed, which is determined according to an actual design requirement.

Accordingly, during the operation phase OPE of the power conversion apparatus 10, when the control signal CS₁ has the high level, it represents that the rectification signal AC_IN′ is to be sampled. Moreover, the comparator 401 outputs the corresponding comparison signal CMP to the DSP 403 for each sampling. For example, when the rectification signal AC_IN′ is sampled to cause the current flowing through the transistor M₅ to be less than the current Iref of the reference current source I, the comparator 401 outputs the low level comparison signal CMP. Conversely, when the rectification signal AC_IN′ is sampled to cause the current flowing through the transistor M₅ to be greater than the current Iref of the reference current source I, the comparator 401 outputs the high level comparison signal CMP. In this way, the DSP 403 obtains 48 batches of comparison signals CMP respectively corresponding to 48 samplings of the rectification signal AC_IN′ for recording.

Once one of the 48 batches of comparison signals CMP has the high level, the DSP 403 determines that the AC voltage AC_IN is stable (i.e. the peak value of the rectification signal AC_IN′ has reached to the minimum voltage (90 Vac) required by the electronic device LD), so as to provide the high level brown-out protection signal BOP to the PWM signal generator 109 after performing 48 samplings to the rectification signal AC_IN′. Therefore, the PWM signal generator 109 starts to provide the PWM signal V_{PWM} to switch the power switch Q₁, so that the power conversion apparatus 10 may supply the output voltage V_{OUT} to the electronic device LD. In other words, during the operation phase OPE of the power conversion apparatus 10, before the AC voltage AC_IN is stable, the brown-out protection unit 111 may control the PWM control chip 105 to stop providing the PWM signal V_{PWM} until the AC voltage AC_IN becomes stable (i.e. the peak value of the rectification signal AC_IN′ has reached to the minimum voltage (90 Vac) required by the electronic device LD). In this way, the problem mentioned in the related art can be effectively resolved.

According to the above descriptions, a brown-out protection method for the power conversion apparatus is deduced below for those skilled in the art.

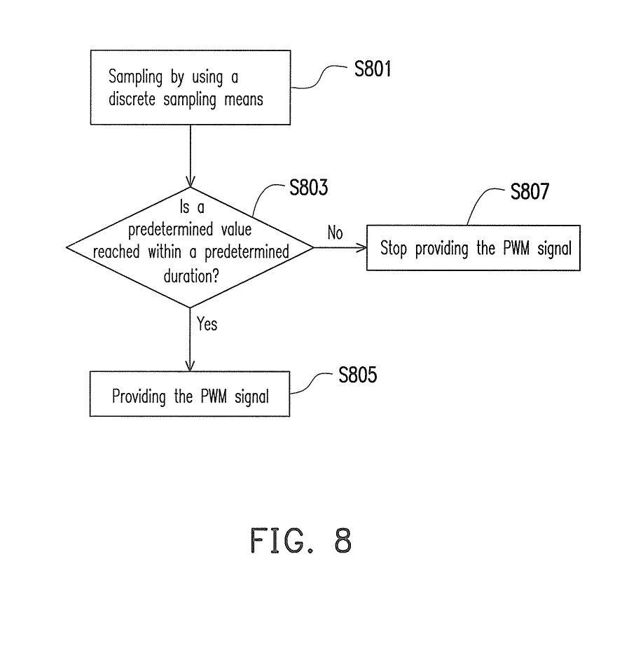

FIG. 8 is a flowchart illustrating a brown-out protection method for a power conversion apparatus according to an embodiment of the invention. Referring to FIG. 8, the brown-out protection method can be described as follows.

A rectification signal relating to an AC voltage received by the power conversion apparatus is sampled by using a discrete sampling means (step S801).

It is determined whether a peak value of the sampled rectification signal has reached to a predetermined value within a predetermined duration (step S803).

When the peak value of the sampled rectification signal has reached to the predetermined value within the predetermined duration, a PWM control chip in the power conversion apparatus provides a PWM signal to switch a power switch in the power conversion apparatus, so as to make the power conversion apparatus provide an output voltage to an electronic device (step S805). Otherwise, the PWM control chip stops providing the PWM signal (step S807).

In summary, according to the power conversion apparatus of the invention, when the received AC voltage is not stable (i.e. brown-out), the power of the PWM control chip is first activated, so that the PWM control chip can further implement the brown-out protection mechanism. Moreover, in the power conversion apparatus and the brown-out protection method of the invention, the discrete sampling means (i.e. a digital signal processing method) is used to sample the rectification signal relating to the AC voltage received by the power conversion apparatus. Once the peak value of the sampled rectification signal has reached to a predetermined value within a predetermined duration (i.e. the AC voltage received by the power conversion apparatus is stable, or reaches a minimum voltage required by the electronic device), the PWM control chip provides the PWM signal to switch the power switch, otherwise (i.e. the AC voltage received by the power conversion apparatus is still not stable, or does not reach the minimum voltage required by the electronic device), the PWM control chip stops providing the PWM signal. In this way, irrevocable damage of the internal devices of the power conversion apparatus and/or the electronic device can be avoided.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power conversion apparatus, comprising:
a power conversion stage, for receiving an alternating current (AC) voltage, and converting the AC voltage to provide an input voltage;
a rectification unit, for receiving the AC voltage, and rectifying the AC voltage to provide a rectification signal;
a transformer, having a primary side, a first secondary side and a second secondary side, wherein a first end of the primary side receives the input voltage, the first secondary side provides an output voltage to an electronic device, and the second secondary side provides a system voltage;
a first power switch, having a first end coupled to a second end of the primary side, a second end coupled to a ground potential, and a control end receiving a pulse width modulation (PWM) signal; and
a PWM control chip, coupled to the rectification unit, the transformer and the first power switch, for receiving the system voltage, and operated under the system voltage with assistance of the rectification signal, and further for sampling the rectification signal by using a discrete sampling means, so as to provide the PWM signal to switch the first power switch when a peak value of the rectification signal has reached to a predetermined value within a predetermined duration.

2. The power conversion apparatus as claimed in claim 1, wherein the PWM control chip comprises:
a PWM signal generator, coupled to the control end of the first power switch, for providing the PWM signal in response to a brown-out protection signal; and
a brown-out protection unit, coupled to the PWM signal generator, for receiving and providing the rectification signal to assist the PWM control chip operating under the system voltage, and sampling the rectification signal by using the discrete sampling means, so as to output the brown-out protection signal when the peak value of the rectification signal has reached to the predetermined value within the predetermined duration.

3. The power conversion apparatus as claimed in claim 2, wherein the brown-out protection unit comprises:
a first resistor, having a first end receiving the rectification signal;
a second power switch, having a first end coupled to a second end of the first resistor, and a control end receiving a first control signal;
a switch, having a first end coupled to a second end of the second power switch, a second end coupled to the system voltage, and a control end receiving a switching signal;
a first transistor, having a gate receiving the first control signal, and a drain coupled to the second end of the second power switch;
a second transistor, having a gate and a drain coupled to a source of the first transistor, and a source coupled to the ground potential;
a third transistor, having a gate coupled to the gate of the second transistor, and a source coupled to the ground potential;
a fourth transistor, having a source coupled to a bias, and a gate and a drain coupled to a drain of the third transistor;
a fifth transistor, having a gate coupled to the gate of the fourth transistor, and a source coupled to the bias;
a reference current source, coupled between a drain of the fifth transistor and the ground potential;
a sixth transistor, having a gate receiving a second control signal inverted to the first control signal, a drain coupled to the drain of the fifth transistor, and a source coupled to the ground potential;
a comparator, having a first input terminal coupled to the drain of the fifth transistor, a second input terminal receiving a reference voltage, and an output terminal outputting a comparison signal; and
a digital signal processor, for providing the first control signal, the second control signal and the switching signal during an initial phase of the power conversion apparatus, so that the PWM control chip is operated under the system voltage with assistance of the rectification signal, and providing the first control signal and the second control signal in response to a clock signal during an operation phase of the power conversion apparatus, so as to perform a discrete sampling to the rectification signal, and record the comparison signal relating to the discrete sampling, and accordingly output the brown-out protection signal when the peak value of the rectification signal has reached to the predeteimined value within the predetermined duration.

4. The power conversion apparatus as claimed in claim 3, wherein the predetermined duration comprises N cycles of the rectification signal, and N is a positive integer.

5. The power conversion apparatus as claimed in claim 4, wherein the first control signal and the second control signal provided by the digital signal processor during the initial phase of the power conversion apparatus are used to sample each of the N cycles of the rectification signal for M times, so that the digital signal processor samples the rectification signal for N*M times during the initial phase of the power conversion apparatus, wherein M is less than N.

6. The power conversion apparatus as claimed in claim 5, wherein
an i-th sampling time Tᵢ that the digital signal processor samples the rectification signal is equal to an (i−1)-th sampling time Tᵢ₋₁ added by a predetermined time, wherein i is an odd positive integer; and
an (i+1)-th sampling time Tᵢ₊₁ that the digital signal processor samples the rectification signal is equal to the i-th sampling time Tᵢ added by the predetermined time and a offset time ΔT.

7. The power conversion apparatus as claimed in claim 3, wherein
the first and the second power switches, the first to the third transistors and the sixth transistor are respectively an N-type transistor; and
the fourth and the fifth transistors are respectively a P-type transistor.

8. The power conversion apparatus as claimed in claim 3, wherein a size of the second transistor is K times greater than that of the third transistor, and sizes of the fourth transistor and the fifth transistor are the same, wherein K is a positive integer.

9. The power conversion apparatus as claimed in claim 1, wherein the power conversion stage comprises:
a full-bridge rectifier, for receiving the AC voltage, and performing a full-wave rectification to the AC voltage for outputting; and
a filter capacitor, coupled to the full-bridge rectifier, for filtering an output of the full-bridge rectifier, so as to provide the input voltage.

10. The power conversion apparatus as claimed in claim 1, wherein the rectification unit comprises:
a first diode; and
a second diode,
wherein anodes of the first and the second diodes receive the AC voltage, and cathodes of the first and the second diodes provide the rectification signal.

11. The power conversion apparatus as claimed in claim 1, further comprising:
a sensing resistor, coupled between the second end of the first power switch and the ground potential.

12. The power conversion apparatus as claimed in claim 11, wherein the PWM control chip further comprises:
an over-current protection unit, coupled to a node between the first power switch and the sensing resistor, for receiving and comparing a voltage of the node and a predetermined over-current protection reference voltage, so as to determine whether or not to activate an over-current protection mechanism to control the PWM signal generator to whether or not generate the PWM signal.

13. The power conversion apparatus as claimed in claim 1, further comprising:
a feedback unit, for receiving the output voltage, and accordingly outputting a feedback signal relating to a loading status of the electronic device.

14. The power conversion apparatus as claimed in claim 13, wherein the PWM control chip further adjusts the PWM signal according to the feedback signal.

15. A brown-out protection method, for a power conversion apparatus, comprising:
sampling a rectification signal relating to an AC voltage received by the power conversion apparatus by using a discrete sampling means; and
when a peak value of the sampled rectification signal has reached to a predeteiniined value within a predetermined duration, making a pulse width modulation (PWM) control chip in the power conversion apparatus provide a PWM signal to switch a power switch in the power conversion apparatus, so as to make the power conversion apparatus provide an output voltage to an electronic device; otherwise, making the PWM control chip to stop providing the PWM signal.
